(19) United States
(12) Patent Application Publication
(10) Pub. No.: US 2006/0121439 A1
(43) Pub. Date: Jun. 8, 2006

(54) Organ preservation and transportation apparatus and method

(76) Inventor: Jan Baker, Dixon, CA (US)

Correspondence Address: LUCAS & MERCANTI, LLP, 475 PARK AVENUE SOUTH, 15TH FLOOR, NEW YORK, NY, 10016, US

(21) Appl. No.: 10/528,119

(22) PCT Filed: Sep. 17, 2003
(86) PCT No.: PCT/US03/29800

§ 371 Date: Mar. 16, 2005

Related U.S. Application Data
(60) Provisional application No. 60/411,691, filed on Sep. 18, 2002.

(51) Int. Cl. A01N 1/02

(52) U.S. Cl. 435/1.2; 435/284.1

(57) ABSTRACT

Apparatus and method for preserving an organ via perfusion at hypothermic and/or normothermic temperature in which an organ-receiving container is arranged in a housing and contains a medium compatible for preserving the organ. A connector detachably mates with the container to alternately enable access to an interior of the container through an opening and seal the opening. A gas source is arranged in the housing and gas therefrom is directed into the container through conduits. Preserving medium is removed from the container and recirculated into the organ such that the preserving medium flow to the organ and the gas flow into the container are separate from one another. Gas is thus absorbed into the medium only in the container. The container is a separate unit from the housing and is separable from the housing. The container can be rendered a self-standing disposable unit which is easily replaced and inclusive of perfusion medium.

### CROSS REFERENCE TO RELATED APPLICATION

This application claims the benefit of priority from U.S. Provisional Patent Application Ser. No. 60/411,691 filed Sep. 18, 2002, the contents of which are incorporated herein by reference.

### FIELD OF THE INVENTION

The present invention relates generally to portable apparatus for preserving and transporting organs between donors and recipients while maintaining the organ's viability.

The present invention also relates to a perfusion system and method for hypothermic and/or normothermic preservation of organs for transplant purposes.

The present invention also relates to organ-storage compartments or containers inclusive of perfusion medium for use in organ preservation and perfusion systems and more specifically to containers inclusive of perfusion medium which are designed to receive organs and enable perfusion of the organs with only a single sterile connection between the container and the organ.

### BACKGROUND OF THE INVENTION

As improvements in clinical transplantation of human organs such as kidneys advance, there is a growing need for preserving organs from both heart-beating and non-heart-beating donor pools until they can be transplanted. At the same time, the costs for performing a transplant operation are also increasing. Often, part of the cost is caused by the need for a special transportation unit to transport the organ from the donor to the recipient who may be situated a distance away from the donor. Generally, the compartment in which the organ is preserved is built into the transportation unit and thus is not replaceable.

For preservation, a perfusion medium which can be oxygenated is used such that gas-containing perfusion medium flows into the organ in order to attempt to maintain the viability of the organ.

Various apparatus exist in the prior art which include a built-in organ-storage compartment and/or provide for an oxygenated perfusion medium to be directed into the organ.

For example, U.S. Pat. No. 5,362,622 (O'Dell et al.) describes an organ preservation apparatus including a chamber receivable of the organ built into the apparatus. A perfusion medium is directed from an inlet valve through an inlet tube into the organ and removed from outlet valve. Oxygenation of the medium is provided by pumping oxygen into a compartment above a gas permeable membrane which separates the gas compartment from the organ-storage compartment. This, in turns, cause the perfusion medium in the organ-storage compartment to be oxygenated and the membrane to expand the oxygen, thereby causing the oxygenated medium to flow into the inlet valve. Thus, oxygenated medium is directed into the organ.

U.S. Pat. No. 5,356,771 (O'Dell) discloses another organ preservation apparatus in which the organ is placed in an organ-storage chamber and a pumping chamber is provided alongside the organ-storage chamber. The perfusate in the pumping chamber is oxygenated by pumping oxygen above a gas permeable membrane which allows oxygen into the perfusate in the pumping chamber and also expands causing flow of oxygenated perfusate from the pumping chamber into the tissue chamber. An outlet channel allows flow of perfusate from the tissue chamber to the pumping chamber during off-cycles of the pump. As such, oxygenated perfusate flows into the organ.

U.S. Pat. No. 5,586,438 (Fahy) shows a portable device for preserving organs by perfusion in which an organ container receives an organ and a circulating system is provided to circulate a perfusion liquid into the organ.

U.S. Pat. Nos. 5,476,763 and 5,285,657 (Bacchi et al.) shows a medical transport assembly which includes a container for the harvested organ or tissue with a perfusion bag for circulating perfusion liquid through the container. The container includes a body and a lid through which a pipe passes to provide fluid to the organ.

U.S. Pat. No. 5,326,706 (Yland et al.) shows a homoeostatic organ preservation system which includes a chamber for holding the organ along with a pump for perfusion liquid.

U.S. Pat. Nos. 3,490,438, 3,717,199, 4,473,637, 5,965,433 and 6,046,046 describe other portable organ preservation apparatus.

The apparatus described above generally do not provide an organ preservation and transportation apparatus including a low-cost, disposable, replaceable organ-storage compartment which can be discarded after preservation and transportation of an organ whereby a new compartment inclusive of perfusion medium can be used in the apparatus for each additional organ. The present invention addresses this need.

### OBJECTS AND SUMMARY OF THE INVENTION

It is therefore an object of the present invention to provide a new and improved portable apparatus and method for preserving organs.

It is another object of the present invention to provide a new and improved portable apparatus and method for preserving organs which has a low-cost, replaceable organ-storage compartment, optionally, but preferably inclusive of perfusion medium.

It is yet another object of the present invention to provide a new and improved portable apparatus and method for preserving organs which includes an organ-storage compartment separable from a housing of the apparatus and optionally, but preferably inclusive of a perfusion medium.

It is still another object of the present invention to provide a new and improved portable, stand-alone apparatus for preserving organs which includes a self-contained power supply.

It is yet another object of the present invention to provide a new and improved perfusion system and method for hypothermic and/or normothermic preservation of organs for transplant purposes.

It is another object of the present invention to provide new and improved organ-receiving compartments or containers optionally, but preferably inclusive of a perfusion medium for use in organ preservation and perfusion systems and more specifically to containers inclusive of perfusion medium which are designed to receive organs and enable perfusion of the organs with only a single sterile connection between the container and the organ.

In order to achieve the above objects, an apparatus for preserving an organ via perfusion at hypothermic and/or normothermic temperature comprises a housing, an organ-receiving container arranged in the housing and optionally, but preferably containing a medium compatible for preserving the organ, a connector detachably mating with the container to alternately enable access to an interior of the container through the opening and seal the opening, a gas source arranged in the housing, an arrangement for directing gas from the gas source into the container; and an arrangement for removing medium from the container and recirculating the medium into the organ. Thus, the preserving medium flow to the organ and the gas flow into the container are separate from one another so that the gas is absorbed into the medium only in the container.

The container is a separate unit from the housing and is separable from the housing. By providing organ-receiving containers which are separable from the housing and operatively containing a perfusion medium, each container can be discarded after each use and replaced with a new container inclusive of perfusion medium without requiring an entirely new apparatus. This avoids the need to constantly purchase expensive new organ transplant apparatus. The containers can be manufactured at substantially less cost than the cost of manufacturing a new apparatus.

In a preferred embodiment, the container is made of a flexible material in the form of a bag and can also be referred to as a bio-containment bag. The bio-containment bag is preferably filled with a suitable perfusion medium prior to use and then packaged in a sterile manner.

The arrangement for directing gas from the gas source into the container may include an external conduit leading from the gas source to a hose barb formed in connection with the container and an internal conduit attached to the hose barb in an interior of the container. A filter can be arranged in connection with the external conduit for filtering the gas from the gas source. Also, a gas bubbler or other type of gas release mechanism may be arranged at an outlet end of the internal conduit.

The arrangement for removing medium from the container and recirculating the medium into the organ may include a pump, a first hose barb formed in connection with the container, an intake conduit arranged in the container and attached to the first hose barb, a pump conduit connected to the first hose barb and another or second hose barb formed in connection with the container and an organ supply conduit arranged in an interior of the container and attached to the second hose barb. The organ supply conduit is adapted to be attached to the organ. The pump conduit is engaged with a pump to provide for a pumping action of medium through the pump conduit.

Another embodiment of an apparatus for preserving an organ includes a housing, an organ-receiving container arranged in the housing and containing a medium compatible for preserving the organ, a bung removably connected to the container to seal an opening in the container, a gas source arranged in the housing, an arrangement for directing gas from the gas source through a passage in the bung into the container, and an arrangement for removing medium from the container and recirculating the medium into the organ through another passage in the bung. Thus, the preserving medium flow to the organ and the gas flow into the container are separate from one another so that the gas is absorbed into the medium only in the container.

To provide for the separate flows of gas and preserving medium, the bung includes two tubes or pipes, each defining one passage and having an upper end outside of the container and a lower end inside the container. In this manner, it is possible to separately regulate the flow of preservation medium to the organ and gas to the container. In prior art constructions wherein the preservation medium is perfused with the gas prior to introduction into the organ-receiving chamber, changes in the perfusion rate are more difficult.

The container used for organ preservation may be used independent of the apparatus disclosed herein, i.e., in other organ preservation apparatus. In such a case, the container, or bio-containment bag, may comprise a film forming a receptacle having a main opening and three flow openings, a connector part surrounding the main opening, a connector detachably mating with the connector part to alternately enable access to the receptacle and seal the receptacle, three hose barbs each arranged in connection with a respective flow opening, a gas conduit attached in the container to a first hose barb for enabling a flow of gas to be introduced into the receptacle, an organ supply conduit attached in the container to a second hose barb for enabling a flow of presevation or perfusion medium to be directed to an organ when attached to the organ supply conduit, and a medium intake conduit attached in the container to a third hose barb for enabling medium to be drawn from the receptacle for recirculation. A pump conduit extends between the second and third hose barbs outside of the container for engagement with a pump to enable the perfusion medium to be pumped from the medium intake conduit to the organ supply conduit.

Additional features of such a bio-containment container include a vent formed in connection with the film for venting gas from the receptacle, the weighting of a medium inlet end of the medium intake conduit to ensure that it is below the level of medium in the container and a gas release mechanism arranged at a gas outlet end of the gas conduit.

As a result of the present invention there are provided portable apparatus for preserving organs which include a low-cost replaceable organ-storage compartment inclusive of perfusion medium to allow the apparatus to be used repeatedly. Other and further advantages will be apparent in view of the following figures and description.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a top view of a first embodiment of an apparatus in accordance with the invention with the apparatus shown in an open position.

FIG. 2 is a perspective view of a first embodiment of a container in accordance with the invention for use in an organ preservation and transportation method and apparatus shown inclusive of perfusion medium.

FIG. 3 is a side view of the apparatus in accordance with the invention with the apparatus shown in a closed position.

FIG. 4 is a perspective view of the housing of the apparatus in accordance with the invention shown in FIG. 1.

FIG. 5 is a perspective view of a stabilizer for use with the apparatus in accordance with the invention shown in FIG. 1.

FIG. 6 is a top view of a second embodiment of an apparatus in accordance with the invention with the apparatus shown in an open position.

FIG. 7 is a schematic diagram of the fluid flow components in the second embodiment of the apparatus in accordance with the invention.

### DETAILED DESCRIPTION OF THE PREFERRED EMBODIMENTS

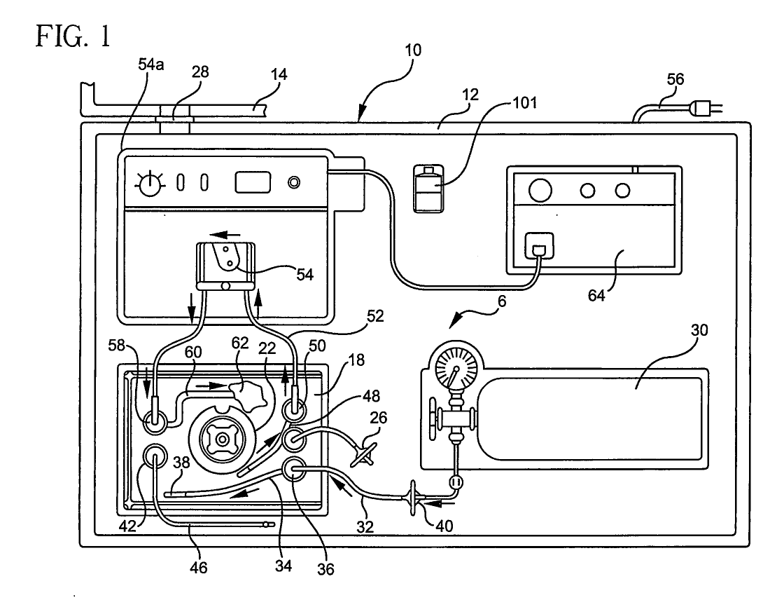

Referring first to FIGS. 1-5, the apparatus in accordance with the invention includes a mounting structure or housing 10 having a base 12 and a cover 14. Hinges 28 pivotally connect the cover 14 to the base 12 and enable the cover 14 to pivot with respect to the base 12 to thereby enable access to an interior of the housing 10.

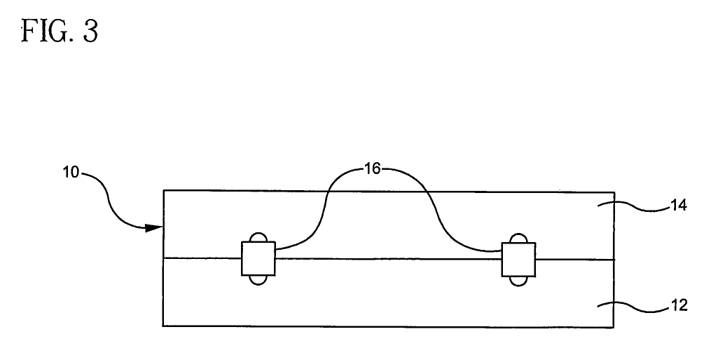

As shown in FIG. 3, cooperating locking mechanisms 16 are provided on the base 12 and cover 14 to lock the cover 14 to the base 12 and close the housing 10, for example, during transport of an organ. It will be understood that alternative means for maintaining the cover on the base are envisioned and will be apparent to those of ordinary skill.

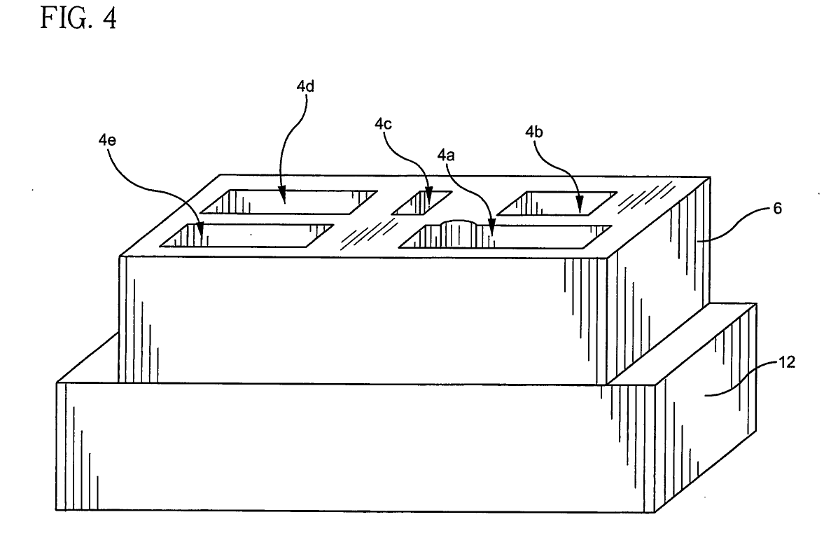

The base 12 of the housing 10 includes a mounting module or structure 6 to retain the components which enable the preservation of the organ, for example, during transport. As shown in FIG. 4, the mounting structure 6 includes compartments 4 receivable of the different components and dimensioned accordingly. The mounting structure 6 is preferably constructed of high-density polystyrene foam in order to provide stability, shock absorbency and, if necessary, thermal insulation. Other materials known to those of ordinary skill which provide stability, shock absorbency and thermal insulation can also be used in the invention. Further, the mounting structure can include several materials or systems whereby each material or system might provide only one of the foregoing functions, e.g., one material or system is used for stability, another for shock absorbency and another for thermal insulation.

The components which provide for the preservation of the organ includes an organ-receiving compartment or container also referred to as a bio-containment bag 18 which defines an interior which is preferably at least partially filled with a perfusion medium 8 and which retains the organ in the medium when needed for transplate. The medium is one which is capable of maintaining physiological pH and osmotic balance through the preservation/transportation process. An exemplary medium is VIASPAN™, a product of DuPont Merck Pharmaceutical Company. Others will be apparent to those of ordinary skill. See also, for example, U.S. Pat. Nos. 6,235,500, 4,911,929, 4,133,874, 5,049,391, 5,674,528, the contents of each of which are incorporated herein by reference. The apparatus and methods of the present invention are not limited to any specific preservation media.

The bio-containment bag 18 maybe made of a Class VI approved monoweb film consisting of an inner fluid/organ contact layer made of low-density polyethylene (LDPE), an outer layer comprised of a blend of LDPE and EVA to provide flexibility and durability to the bio-containment bag 18 and an intermediate gas barrier layer made of EVOH to prevent gas exchange between the interior of the bio-containment bag 18 and the atmosphere. An example of bio-containment bag 18 for use in the invention is manufactured by Newport Biosystems, Inc. of Anderson, Calif. and sold under the trademark BIOBAG™.

The bio-containment bag 18 includes a connector 20 which mates with a cap 22 to seal the bio-containment bag 18 with a sealing gasket 24 being interposed between the cap 22 and connector 20. The connector 20 may be a screw-type connector with exterior threads whereby the cap 22 includes internal threads. Connector 20 is preferably fixed to the bio-containment bag 18, and preferably formed integral therewith to avoid leaks of the perfusion medium from the bio-containment bag 18.

Bio-containment bag 18 is separable from the base 12 of the housing 10. As such, it can be discarded after use and replaced with another bio-containment bag 18. The bio-containment bags 18 are designed to be manufacturable at a relatively low cost, relative to the cost of the entire apparatus and other comparable organ preservation and transportation apparatus.

Bio-containment bag 18 preferably includes a vent 26 which enables gas to be vented from the interior of the bio-containment bag 18. Vent 26 may include a suitable membrane filter, i.e. about 0.2 μm or sized as necessary, housed in a plastic module formed integral with the bio-containment bag 18. In the alternative, the vent 26 may be connected to conduits formed integral with the bio-containment bag 18 by hose clamps or other appropriate attachment mechanism.

In accordance with the invention, two separate fluid flows are passed into the interior of the bio-containment bag 18, namely, gas which perfuses the medium in the bio-containment bag 18 and a preservation/stabilization medium which is directed into and around the organ to bathe and/or perfuse the organ. The gas flow, which is preferably a mixture of oxygen and carbon dioxide, originates in a gas cylinder 30 and flows into a conduit 32 external of the bio-containment 18 and which is in flow communication with a conduit 34 inside the bio-containment bag 18. To allow for the gas flow from conduit 32 to conduit 34, a hose barb 36 is sealed into the bio-containment bag 18 in connection with conduit 34 and conduit 32 is attached to the hose barb 36 with hose clamps or other suitable attachment mechanism. Conduit 34 leads to a gas bubbler 38 or other type of gas diffusion or release device. The other end of the conduit 32 maybe attached to the gas source using hose clamps or other similar attachment mechanism. Instead of the use of hose barbs, other devices for permitting fluid flow through the film forming the bio-containment bag 18 while enabling attachment of one or more conduits thereto may be used.

Exemplifying mixtures of oxygen and carbon dioxide for use in the invention range from about 20% to about 95% oxygen with the reminder typically being carbon dioxide. Mixtures of O₂ and CO₂ within this range typically used for in vitro or ex-vivo organ preservation are also contemplated. This mixture will vary, of course, depending on the conditions of organ preservation and organ being preserved. Other gases or gaseous mixtures suitable for in vitro organ preservation could also be used in accordance with the invention.

A filter 40 is arranged in connection with conduit 32 to filter the gas. The filter 40 is preferably a sterile membrane filter and operates to provide purified gas to the medium in the bio-containment bag 18. Suitable filters can remove particulates and mesophilic bacteria and fungi, down to about 0.2 μm, or smaller, depending upon the needs of the artisan. In use, gas flows from the gas cylinder 30 through the filter 40 into the conduit 32 and through the hose barb 36 into the conduit 34 to the gas bubbler 38 where it is released and thereby perfuses the medium.

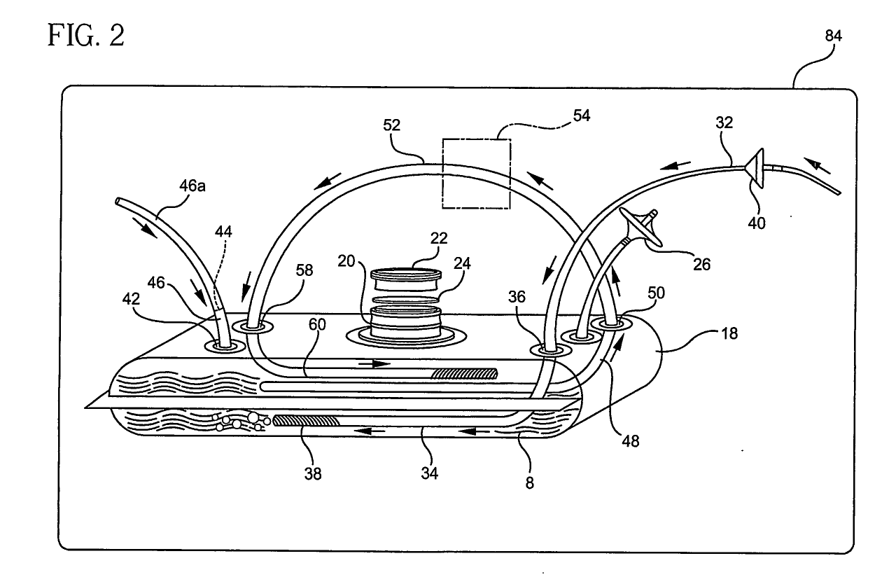

The other fluid flow is a liquid flow of a perfusion medium. Initially, the bio-containment bag 18 is preferably provided with a quantity of a suitable perfusion medium 100 from a perfusion medium source through an intake conduit 46 attached to a hose barb 42 sealed into the bio-containment bag 18. The hose barb 42 and conduit 46 are formed with the bio-containment bag 18 to ensure the sterility of the introduction of perfusion medium into the bio-containment bag 18. Once a sufficient amount of perfusion medium 100 for preservation of an organ is placed into the bio-containment bag 18 through the conduit 46, the conduit 46 is heat-sealed off, i.e., heat-sealed with the portion 46a above the heat seal 44 being removed (represented by the dotted line in FIG. 2).

During operation, the liquid, i.e. perfusion medium 100, to be circulated or recirculated is received from a weighted intake conduit 48 connected to a hose barb 50 sealed into the bio-containment bag 18. Referring now to FIG. 2 in particular, the end of the intake conduit 48 is weighted so that the conduit 48 extends below the level of medium in the bio-containment bag 18 and thus does not draw gas from the bio-containment bag 18. One end of another conduit 52 is connected to the hose barb 50 using hose clamps or the like and the other end is connected to another hose barb 58 using hose clamps or the like. Conduit 52 is placed into engagement with a pump 54. Another conduit 60 is connected to the hose barb 58 and is operatively connected to an artery of the organ 62, for example, the renal artery when the organ is a kidney. The connection between the conduit 60 and the artery of the organ can be any type of known connector structure for attaching a medical tube to an artery such as a catheter device and surgical clamp device. Optionally, a shunt may be arranged at the end of conduit 60.

The pump 54 cycles the perfusion medium continuously through the organ thereby preserving the viability and function of the organ. Pump 54 may be a peristaltic pump so that it does not have any contact with the liquid being pumped through the conduit 52.

In one embodiment, a rechargeable (e.g. 12 V) power pack 64 is provided and the pump 54 plugs into the power pack using a suitable adaptor and receives power from the power pack 64. Power pack 64 can be recharged via a cord connection 56 on the outside of the housing 10 and a spare power pack can be included in the housing 10 for instances when it would not be possible to recharge the power pack prior to exhaustion of the power supply in a single power pack. Also, the cord connection can be used to power the pump 54 when plugged into an external power source.

The entire bio-containment bag 18 and connections may be wrapped inside a sack 84 to maintain sterility of the components. The sack 84 can aseptically contain the bio-containment bag 18, the conduits and devices inside it (conduits 34, 48, 60, gas release mechanism 38), the external conduits and devices (conduits 32, 52, vent 26, filter 40) and the cap 22 and gasket 24. The sack, in turn, is then placed in the housing 100 stored until 101.

As shown in FIG. 4, the compartments 4 in the mounting structure 6 are dimensioned for each component. Thus, compartment 4a is sized to receive the gas source 30, compartment 4b is sized to receive the power pack 64, compartment 4c is sized to receive a supply of pharmaceuticals, such as antibiotics, for use in the organ preservation procedure, compartment 4d is sized to receive the pump 54, its control unit 54a, and compartment 4e is sized to receive the bio-containment bag 18.

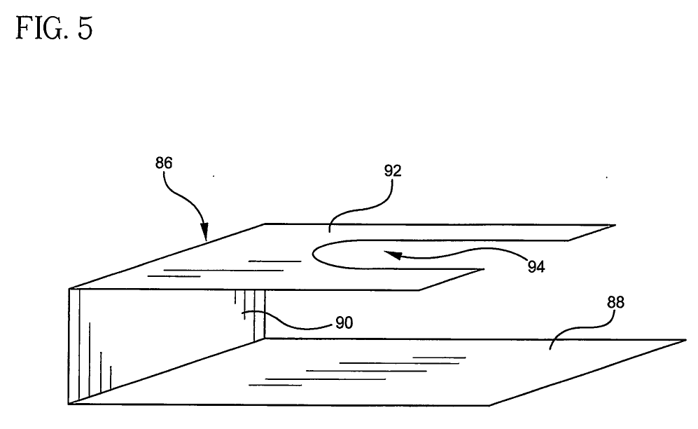

As shown in FIG. 5, a stabilizer 86 may be used to support the bio-containment bag 18 in the compartment 4e. The stabilizer 86 has a base 88, a side wall 90 and an upper wall 92 opposed to the base 88 and having a slot 94. The slot 94 is designed to slide into engagement with the connector 20 or cap 22 to thereby maintain the bio-containment bag 18 is a stable position during transport.

To use the apparatus, a transplant facility would obtain the apparatus and a supply of at least one bio-containment bag. The bio-containment bags are sealed and preferably include an acceptable preservation medium. They thus constitute a sterile, filled and closed system without conduits which require cleaning or replacement. Generally, the bio-containment bags will have a shelf life of several months when stored appropriately, e.g., at a temperature of from about 4° C. to about 8° C. Prior to use, each bio-containment bag should be brought to room temperature but may be kept at a temperature of from about 4° C. to about 8° C. depending on the perfusion operation. In alternative aspects of the invention there is provided a kit containing unfilled bio-containment bags which can be filled with the preservation solution desired by the user.

When a transplant operation of an organ such as a kidney is scheduled, one bio-containment bag inclusive of perfusion medium is removed from cold storage and brought to ambient temperature. Alternatively, if the system employed does not include the perfusate in the bag, it is added to the bag, preferably prior to placement of the organ therein. The apparatus, which may be stored at room temperature, is brought to the sterile surgery suite where the kidney is aseptically removed from the donor and prepared for transplantation into a recipient. This may entail for example, flushing the kidney with a salt solution until all waste product and blood is removed.

The apparatus is opened to expose its interior and the sack 84, if present, is unsealed or cut open. The cap 24 is then separated from the bio-containment bag 18 to expose the organ-entry opening. The kidney is attached by the renal artery to conduit 60 which may be done either inside of the bio-containment bag 18 or outside of it by pulling the conduit 60 through the opening. Before placing the kidney into the bio-containment bag 18, antibiotics may be added. The kidney is then placed into the bio-containment bag 18 and the cap 22 sealed to the connector 20. Conduit 32 is then connected to the hose barb 36 and/or the gas source 30. Conduit 52 is inserted into the pump 54.

Once all of the connections are made and secured, the pump 54 is turned on to begin the perfusion process. The pump 54 may have a pre-programmed operating cycle controlled by a control unit 54a. During operating cycles of the pump 54, perfusion medium is drawn into and through the intake conduit 48, through opening 48a then into and through the conduit 52 and then into and through the conduit 60 into the renal artery of the kidney 62. The rate of perfusion flow will be governed by the needs of the artisan and the organ being preserved/transported. Suitable flow rates range from about less than 10 ml/min to about 80 ml/min. or greater Other considerations such as outflow from the organ pressure gradient etc. will also be considered for the rate of flow.

The gas source 30 is also turned on to allow gas flow to the gas release device or bubbler 38. As such, the gas is perfused into the bio-containment bag 18 where it is absorbed into the medium and transported to the kidney. The cover 14 is then closed and the locking mechanisms 16 engaged. The apparatus is thus ready for transportation.

If the duration of the transport is greater than the pumping time of the pump 54, then the pump 54 is recharged using cord connection 56 to a suitable power outlet source or by replacing the power pack with an optionally included auxiliary power pack disposed in housing 10. Similarly, if the gas source 30 is insufficient for perfusion for the entire duration of the transport of the kidney, then the gas source is replaced as needed.

Once the apparatus arrives at the site of the recipient, the locking mechanisms 16 are disengaged and the cover 14 opened. The cap 22 is separated from the bio-containment bag 18 and the kidney 62 is then removed from the bio-containment bag 18 and the bio-containment bag 18 discarded. The apparatus is placed into storage and if another bio-containment bag inclusive of perfusion medium is not available for immediate use, then a bio-containment bag is ordered.

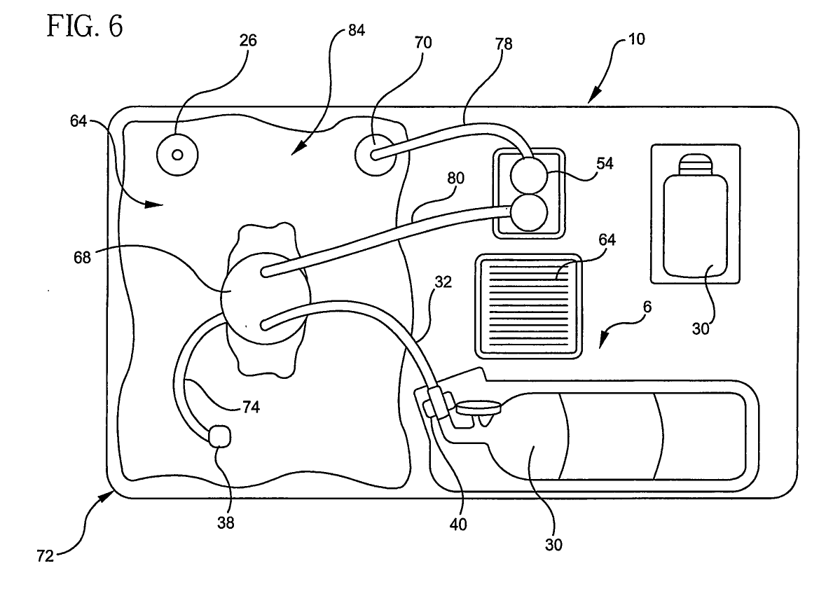

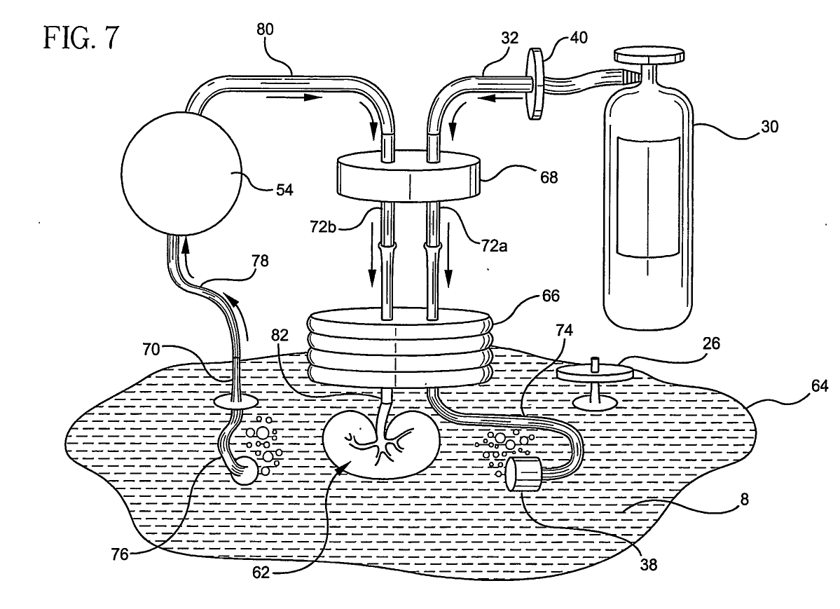

Referring now to FIGS. 6 and 7, a second embodiment of an apparatus in accordance with the invention is shown. In this embodiment, the housing 10, base 12 and cover 14 are used as before but the system included within is modified as described below. The bio-containment bag 64 includes a connector 66 which mates with a bung 68 to seal the bio-containment bag 64. The connector 66 may be a screw-type connector with exterior threads whereby the bung 68 includes internal threads or other matched mating means. Connector 66 is preferably fixed to the bio-containment bag 64, and more preferably formed integral therewith to avoid leaks of the perfusion medium from the bio-containment bag 64.

Bio-containment bag 64 includes a vent 26 which enables gas to be vented from the interior of the bio-containment bag 64. A hose barb 70 is also formed in the bio-containment bag 64, the purpose of which is explained below.

The bung 68 includes two tubes or pipes 72a,72b extending from above the bung 68 to below the bung 68 such that when the bung 68 is mated with the bio-containment bag 64, the pipes 72a,72b each provide a passage from the exterior of the bio-containment bag 64 to the interior of the bio-containment bag 64.

In accordance with the invention, two separate fluid flows are passed into the interior of the bio-containment bag 64, namely, gas which perfuses the medium in the bio-containment bag 64 and a perfusion medium which is directed into the organ to perfuse the organ. The gas flow, which is preferably a mixture of oxygen and carbon dioxide, originates in a gas cylinder 30 and flows into a conduit 32 leading to one of the pipes 72a in the bung 68. Filter 40 is arranged between the gas cylinder 30 and the bung 68 to filter the gas. Conduit 32 is attached to an upper end of the pipe 72a using a hose clamp or other suitable attachment mechanism. To the lower end of the same pipe, a conduit 74 is attached and leads to a gas bubbler 38 or other type of gas release device. Gas thus flows from the gas cylinder 30 through the conduit 32 and filter 40, through the pipe 72a in the bung 68, through the conduit 74 to the gas bubbler 38 where it is released and thereby perfuses the medium.

The other fluid flow is a liquid flow of a perfusion medium. The liquid is received from an intake conduit 76 attached to the hose barb 70 sealed into the bio-containment bag 64. Intake conduit 76 may be weighted so that it is always below the level of medium in the bio-containment bag 64 and thus does not draw in gas from the bio-containment bag 18. Another conduit 78 leads from hose barb 70 to the pump 54 and a conduit 80 leads from pump 54 to the pipe 72b in the bung 68. Conduit 80 is attached to an upper end of the pipe 72b using a hose clamp or the like. Instead of two conduits 78,80, a single conduit can be provided and a pump used with does not contact the fluid, e.g., a peristaltic pump as described above. Another conduit 82 leads from the lower end of the pipe 72b to an artery of the organ, the renal artery when the organ is a kidney 62. The connection between the conduit 88 and the artery of the organ can be any type of known connector structure for attaching a medical tube to an artery such as a catheter device and surgical clamp device.

For use of this embodiment of the apparatus with a kidney removed from a donor, the apparatus is opened to expose its interior and the bung 68 is separated from the bio-containment bag 64. The kidney 62 is attached by the renal artery to the lower end of the pipe 72b on the underside of the bung 68. The conduit 74 connected to the gas release device 38 is attached to the lower end of the pipe 72a on the underside of the bung 68. The conduit 74 and gas release device 38 may be present in the bio-containment bag 64 during storage or added thereto once the bung 68 is separated from the bio-containment bag 64.

Before placing the kidney into the bio-containment bag 64, antibiotics may be added. The kidney is then placed into the bio-containment bag 64 and the bung 68 sealed to the connector 66.

The conduits 32, 78 and 80 are connected, if necessary, between the upper end of the pipe 72a and the gas source 30, between the hose barb 70 on the bio-containment bag 64 and the pump 54 and between the pump 54 and the upper end of pipe 72b, respectively. Once all of the connections, if necessary, are made and secured, the pump 54 is turned on to begin the perfusion process. During operating cycles of the pump 54, perfusion medium is drawn into the intake conduit 76, through the conduit 78 and then into and through the pump 54. From the pump 54, the medium is forced through the conduit 80, through the pipe 72b, through the conduit 82 into the renal artery of the kidney.

The gas source 30 is also turned on to a pre-determined indicator to allow gas flow to the gas release device 38. As such, the gas is perfused into the bio-containment bag 64 where it is absorbed into the medium and transported to the kidney. The cover 14 is then closed and the locking mechanism 16 engaged. The apparatus is thus ready for transportation.

Once the apparatus arrives at the site of the recipient, the locking mechanism 16 is disengaged and the cover 14 opened. The connection to the bung 68 are removed and the bung is then separated from the bio-containment bag 64. The kidney is removed from the bio-containment bag 64 and the bio-containment bag 64 is then discarded. The conduits 32,78 and 80, if reusable, are cleaned and prepared for the next use. The apparatus is placed into storage and if another bio-containment bag is not available for immediate use, then a bio-containment bag is ordered.

Thus, as disclosed above, an organ preservation and transportation apparatus is shown including a disposable and replaceable organ-storage compartment inclusive of perfusion medium. Low-cost organ preservation and transportation is provided because after the initial purchase of the apparatus, the only component which needs to be replaced for each organ is the bio-containment bag 64. The cost of the bio-containment bag inclusive of perfusion medium is quite small relative to the cost of the apparatus.

Throughout the description, mention is made of a kidney as the organ being preserved/transported. It is to be understood that the apparatus and methods described herein can be used with any organ, e.g. heart, liver, etc. or portion thereof. In certain aspects of the invention where no organ artery is available for connection to conduit 60, the transported organ is placed in fluid communication with the conduit end so that the organ is bathed with the perfusate.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

What is claimed is:

1. An apparatus for preserving an organ via perfusion, comprising:
a housing;
an organ-receiving container arranged in said housing and optionally containing a medium compatible for preserving the organ, said container having an opening;
a connector detachably mating with said container to alternately enable access to an interior of said container through said opening and seal said opening;
a gas source arranged in said housing;
means for directing gas from said gas source into said container; and
means for removing medium from said container and recirculating said medium into the organ.

2. The apparatus of claim 1, wherein said container is separable from said housing.

3. The apparatus of claim 1, wherein said means for directing gas from said gas source into said container comprises a first conduit leading from said gas source to a hose barb formed in connection with said container and a second conduit leading from said hose barb into an interior of said container.

4. The apparatus of claim 3, further comprising a filter arranged in connection with said first conduit for filtering the gas from said gas source.

5. The apparatus of claim 4, further comprising a gas release mechanism arranged at an end of said second conduit.

6. The apparatus of claim 1, wherein the medium is VIASPAN™.

7. The apparatus of claim 1, wherein said means for removing medium from said container and recirculating said medium into the organ comprises a pump, a first and a second hose barb formed in connection with said container, an intake conduit arranged in said container and connected to said first hose barb, a pump conduit connected at one end to said first hose barb and at an opposite end to said second hose barb, and an organ supply conduit arranged in said container and connected to said second hose barb, said organ supply conduit being adapted to be attached to the organ, said pump conduit being engaged with said pump to enable said pump to cause flow of medium from said intake conduit through said pump conduit to said organ supply conduit.

8. The apparatus of claim 7, wherein an inlet end of said intake conduit is weighted so as to be situated below a level of medium in said container.

9. The apparatus of claim 1, wherein said housing comprises a mounting structure for receiving said container and said gas source.

10. The apparatus of claim 1, wherein said container comprises a vent for venting gas from said container.

11. The apparatus of claim 1, wherein said container includes a connector part defining said opening.

12. The apparatus of claim 11, wherein said connector and said connector part of said container include a cooperating sealing mechanism.

13. The apparatus of claim 12, further comprising a gasket interposed between said connector and said connector part of said container.

14. The apparatus of claim 1, wherein said gas source comprises a gas cylinder.

15. The apparatus of claim 1, wherein said connector is a bung having a first passage and a second passage, said means for directing gas from said gas source into said container being arranged to direct the gas through said first passage and said means for removing medium from said container and recirculating said medium into the organ being arranged to direct the medium through said second passage.

16. The apparatus of claim 15, wherein said bung includes a first pipe defining said first passage and a second pipe defining said second passage, an upper end of said first and second pipes being arranged on one side of said bung and a lower end of said first and second pipes being arranged on an opposite side of said bung.

17. The apparatus of claim 15, wherein said means for directing gas from said gas source through said first passage and into said container comprises a first conduit leading from said gas source to said first passage and a second conduit arranged in an interior of said container in flow communication with said first conduit.

18. The apparatus of claim 15, wherein said means for removing medium from said container and recirculating said medium into the organ through said second passage comprises a pump, an intake conduit arranged in said container, an outlet conduit connected to said intake conduit and having an end exterior of said container, a pump intake conduit arranged between said outlet conduit and said pump, a pump outlet conduit arranged between said pump and said second passage and an organ supply conduit adapted to be arranged between said second passage and the organ.

19. An apparatus for preserving an organ, comprising:
a housing;
an organ-receiving container arranged in said housing and optionally containing a medium compatible for preserving the organ;
a gas source arranged in said housing;
gas directing means for directing gas from said gas source into said container; and
medium recirculating means for removing medium from said container and recirculating said medium into the organ,
said gas directing means and medium recirculating means being arranged such that the gas and the medium flow separately into said container.

20. The apparatus of claim 19, wherein said gas directing means comprise a first conduit leading from said gas source to a hose barb formed in connection with said container and a second conduit connected to said hose barb in an interior of said container.

21. The apparatus of claim 20, wherein said medium recirculating means comprise a pump, a first and a second hose barb formed in connection with said container, an intake conduit arranged in said container and connected to said first hose barb, a pump conduit connected at one end to said first hose barb and at an opposite end to said second hose barb and an organ supply conduit arranged in said container and connected to said second hose barb, said organ supply conduit being adapted to be attached to the organ, said pump conduit being engaged with said pump to enable said pump to cause flow of medium from said intake conduit through said pump conduit to said organ supply conduit.

22. The apparatus of claim 19, further comprising a connector removably connected to said chamber, said connector having a first passage and a second passage separated from said first passage, said gas directing means being arranged to direct the gas through said first passage and said medium recirculating means being arranged to direct to the medium through said second passage.

23. The apparatus of claim 22, wherein said connector includes a first pipe defining said first passage and a second pipe defining said second passage, an upper end of said first and second pipes being arranged on one side of said bung and a lower end of said first and second pipes being arranged on an opposite side of said bung.

24. The apparatus of claim 23, wherein said gas directing means comprise a first conduit leading from said gas source to said first passage, a gas release mechanism and a second conduit arranged in an interior of said container and leading from said first passage to said gas release mechanism.

25. The apparatus of claim 24, wherein said medium recirculating means comprise a pump, an intake conduit arranged in said container, an outlet conduit connected to said intake conduit and having an end exterior of said container, a pump intake conduit arranged between said outlet conduit and said pump, a pump outlet conduit arranged between said pump and said second passage and an organ supply conduit adapted to be arranged between said second passage and the organ.

26. The apparatus of claim 19, wherein said container is separable from said housing.

27. The apparatus of claim 19, wherein said container is a bio-containment bag made of flexible material.

28. A bio-containment device for use in organ preservation, comprising:
a film forming a receptacle having a main opening and three flow openings;
a connector part surrounding said main opening;
a connector detachably mating with said connector part to alternately enable access to said receptacle and seal said receptacle;
three hose barbs each arranged in connection with a respective one of said flow openings;
a gas conduit connected to a first one of said hose barbs for enabling a flow of gas to be introduced into said receptacle;
an organ supply conduit attached to a second one of said hose barbs for enabling a flow of perfusion medium to be directed to an organ when attached to said organ supply conduit; and
a medium intake conduit attached to a third one of said hose barbs for enabling medium to be drawn from said receptacle for recirculation.

29. The bio-containment device of claim 28, further comprising a medium arranged in said receptacle.

30. A bio-containment device for use in organ preservation, comprising:
a film forming a receptacle having a main opening and one flow opening;
a connector part surrounding said main opening;
a bung detachably mating with said connector part to alternately enable access to said receptacle and seal said receptacle, said bung defining a first passage and a second passage;
a hose barb arranged in connection with said flow opening;
a gas conduit attached to said first passage for enabling a flow of gas to be introduced into said receptacle;
an organ supply conduit attached to said second passage for enabling a flow of a perfusion medium to be directed to an organ when attached to said organ supply conduit; and
a medium intake conduit attached to said hose barb for enabling medium to be drawn from said receptacle for recirculation.

31. A method for enabling preservation and transportation of organs, comprising the steps of:
providing a plurality of organ-receiving containers, each containing a medium compatible for preserving the organ;
for each organ to be preserved,
placing a respective one of the containers into a housing;
removing a bung out of connection with the container to expose an opening in the container;
attaching an artery of the organ to a conduit leading to a first pipe in the bung and placing the organ in the container;
connecting a gas release device to a second pipe in the bung;
connecting the bung to the container to seal the container with the organ inside;
removing medium from the container and recirculating the medium into the organ through the first pipe; and
directing gas from a gas source arranged in the housing through the second pipe in the bung into the medium in the container.
